(19) United States
(12) Patent Application Publication
(10) Pub. No.: US 2021/0358022 A1
(43) Pub. Date: Nov. 18, 2021

(54) MACHINE LEARNING BASED TIERED GRAPHICAL USER INTERFACE (GUI)

(71) Applicant: International Business Machines Corporation, Armonk, NY (US)

(72) Inventors: Wei Sun, Tarrytown, NY (US); Junyu Cao, Albany, CA (US); Shivaram Subramanian, Frisco, TX (US); Jae-Eun Park, Wappingers Falls, NY (US)

(21) Appl. No.: 16/872,423

(22) Filed: May 12, 2020

(51) Int. Cl. G06Q 30/06; G06Q 30/02; G06N 3/02

(52) U.S. Cl. CPC G06Q 30/0643; G06N 3/02; G06Q 30/0201; G06Q 30/0631

(57) ABSTRACT

Techniques for a machine learning based tiered graphical user interface (GUI) are described herein. Aspects of the invention include receiving a set of offered products. The set of offered products is sorted into a plurality of tiers, and an initial tiered GUI is generated based on the sorting. Based on receiving customer feedback via the tiered GUI, the sorting of the set of offered products into the plurality of tiers is updated, and an updated tiered GUI is generated based on the updated sorting.

### BACKGROUND

The present invention generally relates to programmable computers, and more specifically, to programmable computers configured and arranged to utilize machine learning based techniques to generate an improved tiered graphical user interface (GUI).

Many fields incorporate machine learning models to perform tasks that involve analysis of data, and that further involve using the results of that analysis as the basis of future actions. In general, machine learning models are generated by and run on neural networks, which can be implemented as programmable computers configured to run a set of machine learning algorithms. Neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical).

The basic function of neural networks and their machine learning algorithms is to recognize patterns by interpreting unstructured sensory data through a kind of machine perception. Unstructured real-world data in its native form (e.g., images, sound, text, or time series data) is converted to a numerical form (e.g., a vector having magnitude and direction) that can be understood and manipulated by a computer. The machine learning algorithm performs multiple iterations of learning-based analysis on the real-world data vectors until patterns (or relationships) contained in the real-world data vectors are uncovered and learned. The learned patterns/relationships function as predictive models that can be used to perform a variety of tasks, including, for example, classification (or labeling) of real-world data and clustering of real-world data. Classification tasks often depend on the use of labeled datasets to train the neural network (i.e., the model) to recognize the correlation between labels and data. This is known as supervised learning. Examples of classification tasks include detecting people/faces in images, recognizing facial expressions (e.g., angry, joyful, etc.) in an image, identifying objects in images (e.g., stop signs, pedestrians, lane markers, etc.), recognizing gestures in video, detecting voices, detecting voices in audio, identifying particular speakers, transcribing speech into text, and the like. Clustering tasks identify similarities between objects, which it groups according to those characteristics in common and which differentiate them from other groups of objects. These groups are known as “clusters”.

### SUMMARY

Embodiments of the present invention are directed to a machine learning based tiered graphical user interface (GUI). A non-limiting example computer-implemented method includes receiving data representing a set of offered products. The data representing the set of offered products is sorted into a plurality of tiers, and an initial tiered GUI is generated based on the sorting. Based on customer feedback received at the tiered GUI, the sorting of the set of offered products into the plurality of tiers based on the received customer feedback is updated, and an updated tiered GUI is generated based on the updated sorting.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a flow diagram of a process for a machine learning based tiered graphical user interface (GUI) in accordance with one or more embodiments of the present invention;

FIG. 2 is a block diagram of components of a system for a machine learning based tiered GUI in accordance with one or more embodiments of the present invention;

FIG. 3 is a block diagram of components of a machine learning based tiered GUI in accordance with one or more embodiments of the present invention; and

FIG. 4 is a block diagram of an example computer system for use in conjunction with one or more embodiments of a machine learning based tiered GUI.

### DETAILED DESCRIPTION

One or more embodiments of the present invention provide a machine learning based tiered graphical user interface (GUI). In some embodiments of the invention, the tiered GUI can be configured to implement a sequential multinomial logic (SMNL) model that captures customers' sequential choice behavior. A polynomial-time algorithm can be used to solve a profit-maximization problem, and characterize the properties of an optimally sorted tiered GUI. The characteristics of new products can be learned using the tiered GUI. Product feature discovery can be performed by learning relationships between product features (e.g., style, color, trend), customer attributes (e.g., price sensitivity, location), and product valuations (e.g., product attractiveness) based on customer feedback that is received via the tiered GUI. In some embodiments of the invention, product feature data that is acquired via the tiered GUI can be used to select new products to be offered by the seller. For example, in some embodiments of the invention, product feature data can be accumulated for each of a set of products offered by the seller via the tiered GUI over a time period (e.g., a season), and the accumulated product feature data can be used to select new products having features that are correlated to relatively high product valuations to be offered by the seller in a next time period. The selected new products are combined with staple products to implement a next iteration of the machine learning based tiered GUI. Product feature-based prediction can be used to determine trends across different customer segments and product categories for an upcoming season.

Accordingly, a machine learning based tiered GUI in accordance with aspects of the invention can enable a seller (e.g., an e-commerce seller) to learn customer preferences regarding new products while mitigating the risks to profitability inherent in offering the new products. A set of products that is offered by a seller, which can include a mixture of new products and staple (e.g., preexisting or previously offered) products, is presented to customers in a GUI that includes a number of tiers, each tier having a respective prominence level in the GUI. The products in a primary tier (e.g., first tier) can be displayed relatively prominently in the tiered GUI (e.g., first tier products can be centrally positioned in the tiered GUI with enlarged graphics and/or videos). Products in a lower tier (e.g., second or third tier) can be displayed less prominently (e.g., lower in the tiered GUI with smaller graphics) than higher tier products, and/or can be included in subsequent GUI pages. Each tier can include a mixture of new and staple products. Machine learning techniques can be used to sort the offered products into the different tiers, and the sorting of the products into the different tiers can be automatically updated based on customer feedback that is received via the tiered GUI. In some embodiments of the invention, the tiered GUI can be configured and arranged to achieve relatively high profits for a seller by reducing the profit risks associated with the offering of new products. The tiered GUI can be displayed to customers via any appropriate user devices, e.g. mobile devices or personal computers.

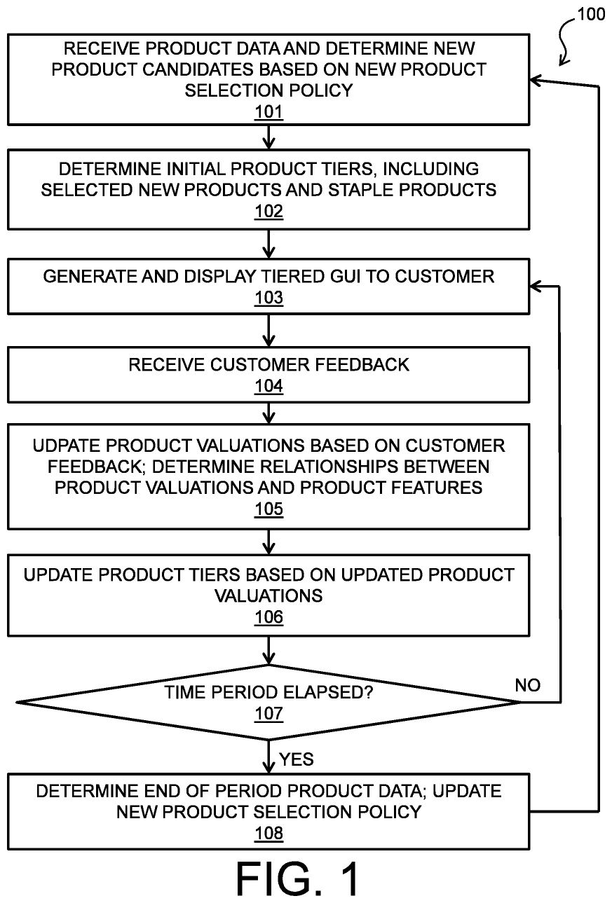

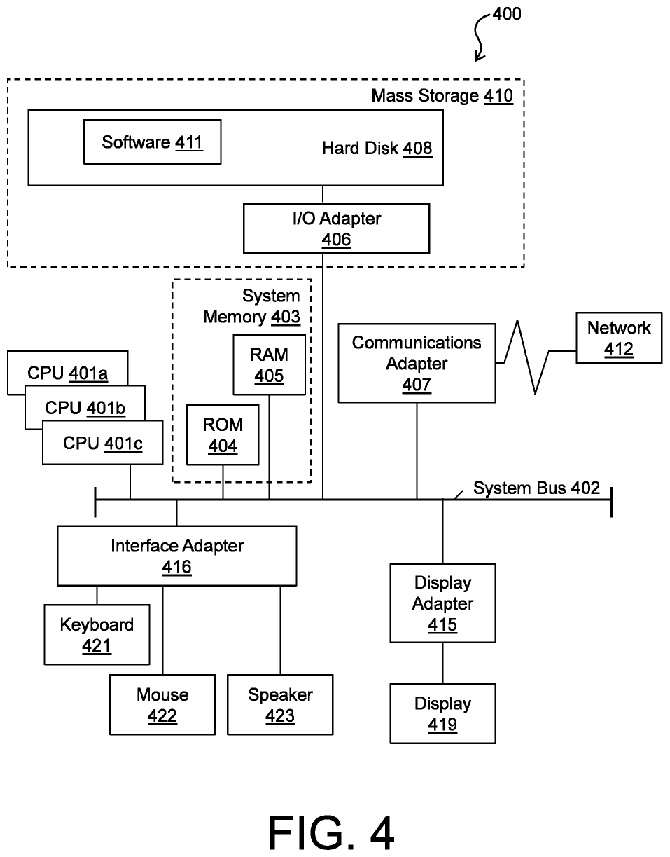

FIG. 1 shows a process flow diagram of a method 100 for implementing a machine learning based tiered GUI in accordance with one or more embodiments of the present invention. In accordance with embodiments of the invention, the method 100 of FIG. 1 can be implemented in conjunction with any appropriate computing device, including but not limited to computing device 400 of FIG. 4. In block 101 of method 100, product data is received, including a set of available new products, and new product candidates are determined. The product data that is received in block 101 can be related to any appropriate type of product that can be offered by a seller for purchase via a GUI. The product data can be received from any appropriate sources in various embodiments of the invention, including but not limited to social media data, customer surveys, market research, supplier data, and inventory data. The product data can also include revenue values (e.g., based on sale price and/or profit per sale) for each product. The new product candidates are selected from the set of available new products in block 101 based on the received product data and based on a new product selection policy; in some embodiments of the invention the new product selection policy can be determined based on a set of product features that were determined based on customer feedback.

In block 102, for a set of offered products, including a mixture of the selected new products that were determined in block 101 and a set of staple products, a set of initial product tiers are determined. For each product of the set of offered products, a product valuation (e.g., an attractiveness), a revenue value, and a set of product features are maintained. In some embodiments of the invention, for a staple product, the product valuation and set of product features are based on historical product data; for the selected new products, the product valuation and set of features are unknown or initialized to default values. The product tiers can be determined in block 102 based on the product valuations and revenue values of the set of offered products, and can be determined such that total revenue for the set of offered products is maximized in some embodiments of the invention. In various embodiments of the invention, the set of offered products are divided into any appropriate number of tiers. In some embodiments of the invention, a higher tier (e.g., a first tier) includes fewer products than a lower tier (e.g., a second tier). In some embodiments of the invention, in the initial sorting of block 102, the first tier can include only staple products, and any lower tiers (e.g., a second tier and/or third tier) can include a mixture of new and staple products. Each product of the set of offered products can be sorted into a single respective tier in block 102.

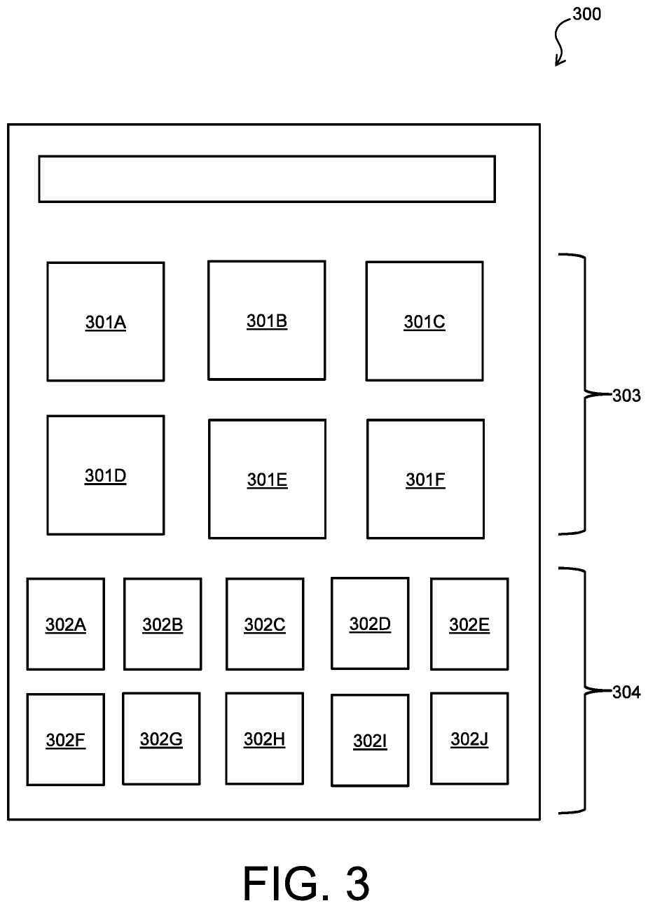

In block 103, a tiered GUI is generated based on the determined product tiers, and the tiered GUI is displayed to a customer via a user device. The tiered GUI can be generated in block 103 based on a request from the user device, and provided to a display of the user device via any appropriate network based on the generation. In some embodiments of the invention, the tiered GUI can display products in a higher tier (e.g., the first tier) with a higher prominence than products in a lower tier (e.g., the second tier). For example, products in the higher tier can be displayed higher in the tiered GUI with larger graphics and/or videos as compared to products in a lower tier. Lower-tier products can also be displayed on subsequent GUI pages in some embodiments of the invention. An example embodiment of a tiered GUI that can be generated and displayed in block 103 is illustrated with respect to FIG. 3.

In block 104, customer feedback is received from the user device via the tiered GUI. The customer feedback that is received in block 104 can include data regarding the customer's interaction with the tiered GUI, including but not limited to a purchase of a product from a specific tier, whether the customer did not purchase any product, and whether the customer viewed products across multiple tiers before making a purchase or otherwise ending the interaction with the tiered GUI. Customer attribute data (e.g., customer persona data and/or customer location) can also be received in block 104 in some embodiments of the invention. In some embodiments of the invention, a survey is presented to the customer regarding the product offerings in the tiered GUI in block 103, and survey response data is received in block 104.

In block 105, product valuations for the set of offered products are updated based on the customer feedback from block 104. In some embodiments of the invention, for a product that was not purchased by the customer, the product valuation can be reduced in block 105. In some embodiments of the invention, for a product that was purchased by the customer, the product valuation can be increased in block 105. The product valuations of any appropriate number of products of the set of offered products can be adjusted in block 105. In some embodiments of the invention, the valuation of a given product can be determined in block 105 based on a number of times the given product is purchased (or not purchased) from a particular tier over a number of instances of customer feedback. Relationships between specific features of one or more products, customer attributes, and the updated product valuations can be determined in block 105. In block 106, the sorting of the set of offered products into product tiers is updated based on the product revenue values and the updated product valuations were determined in block 105. Products from the set of offered products can be moved between tiers in any appropriate manner in block 106. The sorting of the set of offered products that is performed in block 106 can be determined such that total revenue for the set of offered products is maximized in some embodiments of the invention.

In block 107, it is determined whether a time period has elapsed. The time period can be any appropriate amount of time (e.g., a season). If it is determined in block 107 that the time period has not elapsed flow proceeds from block 107 back to block 103, and a tiered GUI is generated and displayed to a customer based on the updated product tiers that were determined in block 106. Blocks 103-107 are repeated for each customer interaction, and the sorting of the set of offered products into the various tiers is updated based on the customer interactions, until it is determined in block 107 that the time period has elapsed. Repetition of blocks 103-106 can cause the respective product valuations of the set of offered products to be learned using the tiered GUI, such that the product valuation for each product of the set of offered products will converge over time.

When it is determined in block 107 that the time period has elapsed, flow proceeds from block 107 to block 108. In block 108, end of period product data is determined, and the new product selection policy is updated based on the end of period product data. In some embodiments of the invention, the end of period product data can include converged product valuations, and determined relationships between product features, product valuations, and customer attributes. Flow of method 100 proceeds from block 108 back to block 101. In block 101, a new set of new product candidates is received, and a new set of offered products is determined based on the updated new product selection policy. For example, the new product selection policy can cause new products having product features that were determined to correlate to relatively high product valuations for customers having particular attributes to be selected in block 101. Blocks 102, and 103-106, are then repeated based on the new set of offered products for the duration of a next time period. Embodiments of method 100 can be repeated for any appropriate number of time periods.

According to embodiments of an SMNL model, a customer selects a product having a highest valuation for the customer among the set of offered products. In some embodiments of the invention, customers can arrive (e.g., request the tiered GUI) at discrete times t=1, . . . , T. For a customer arriving at time t, the customer is presented with a choice set Sₜ. Under the SMNL model, a customer can first consider products from the highest priority tier S₁ for purchase, and if no products from tier S₁ are selected, the customer can then consider a secondary tier S₂ and decides whether to purchase any product from S₂. The customer can also opt not to purchase any product. In some embodiments of the invention, a probability (pᵢ) of a customer purchasing a product i based on the assigned tier of the product i can be determined in blocks 102 and 106 of method 100, as illustrated in Equation (EQ.) 1. In EQ. 1, S₁ is a first product tier, S₂ is a second product tier, i=0 represents no purchase, and vᵢ is the product valuation of product i.

$${p}_{i} ( {S}_{1} , {S}_{2} ) = \{ \begin{matrix}\frac{{v}_{i}}{1 + {\sum }_{j ∈ {S}_{1}} {v}_{j}} , & if i ∈ {S}_{1} \\ \frac{1}{1 + {\sum }_{j ∈ {S}_{1}} {v}_{j}} \frac{{v}_{i}}{1 + {\sum }_{j ∈ {S}_{2}} {v}_{j}} , & if i ∈ {S}_{2} \\ \frac{1}{1 + {\sum }_{j ∈ {S}_{1}} {v}_{j}} \frac{1}{1 + {\sum }_{j ∈ {S}_{2}} {v}_{j}} , & if i = 0 \\ 0 , & otherwise ,\end{matrix} . \qquad EQ . 1$$

A probability according to EQ. 1 can be determined for each of the products in the set of offered products in some embodiments of the invention. An expected revenue (E[R(S)]) for product i based on assignment of product i into one of S₁ or S₂ can be determined according to EQ. 2 in block 106, where rᵢ is a revenue value of product i:

$$E [ R ( S ) ] = \frac{{\sum }_{i ∈ {S}_{1}} {r}_{i} {v}_{i}}{1 + {\sum }_{j ∈ {S}_{1}} {v}_{j}} + \frac{1}{1 + {\sum }_{j ∈ {S}_{1}} {v}_{j}} \frac{{\sum }_{i ∈ {S}_{2}} {r}_{i} {v}_{i}}{1 + {\sum }_{j ∈ {S}_{2}} {v}_{j}} . \qquad EQ . 2$$

The determined expected revenue according to EQ. 2 can be used to assign products from the set of offered products into tiers in some embodiments of the invention of blocks 102 and 106 of method 100 so as to maximize a total revenue of the set of offered products. Further, in some embodiments of block 101 of method 100, for a single new product m for a tiered GUI having two tiers, the new product selection policy can specify that if the revenue value (rₘ) of product m is less than E[R(S₂)], then the product m is not included in the set of offered products; and if the revenue value of product m (rₘ) is greater than or equal to E[R(S₂)], then the product m can be included in set of offered products.

The process flow diagram of FIG. 1 is not intended to indicate that the operations of the method 100 are to be executed in any particular order, or that all of the operations of the method 100 are to be included in every case. Additionally, the method 100 can include any suitable number of additional operations.

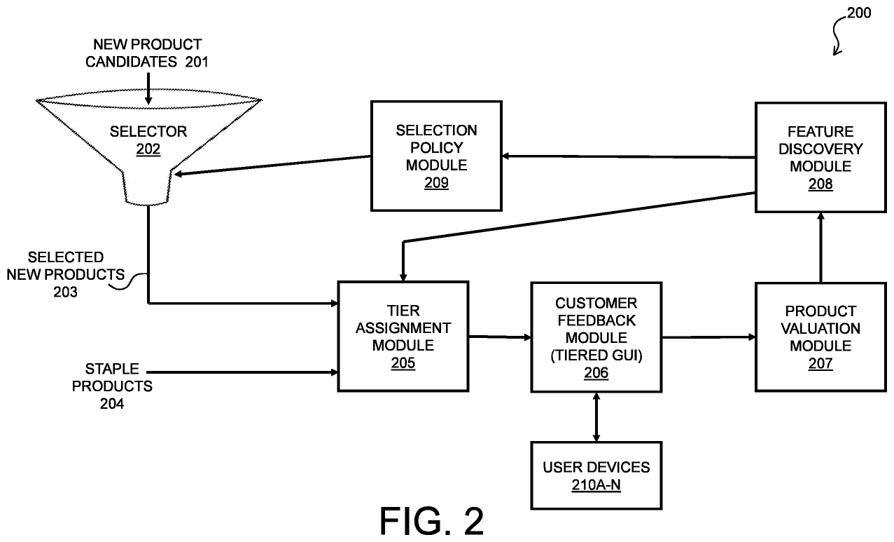

Turning now to FIG. 2, a system 200 for a machine learning based tiered GUI is generally shown in accordance with one or more embodiments of the present invention. Embodiments of system 200 of FIG. 2 can be implemented in conjunction with any appropriate computing device, including but not limited to computing device 400 of FIG. 4. System 200 of FIG. 2 can implement embodiments of method 100 of FIG. 1. In some embodiments of the invention, system 200 can be implemented in a distributed computing environment that includes parallel architecture graphics processing units (GPUs). System 200 includes a selector 202 that receives data regarding a set of new product candidates 201. Data regarding the new product candidates 201 can be received from any appropriate source, as described above with respect to block 101 of method 100 of FIG. 1. The selector 202 determines a set of selected new products 203 that is a subset of the new product candidates 201 based on a new product selection policy received from selection policy module 209. The selected new products 203 and staple products 204 make up a combined set of offered products.

Data regarding the set of offered products is input into tier assignment module 205. The data regarding the set of offered products can include a respective product valuation and revenue value for each of the set of offered products. For selected new products 203, product valuations can be unknown; in some embodiments of the invention, product valuations for the selected new products can be initialized to a default value. Tier assignment module initially assigns each product of the set of offered products to a product tier based on product valuation and product revenue value as described with respect to block 102 of method 100 of FIG. 1, and provides the assigned product tiers to customer feedback module 206. Customer feedback module generates a tiered GUI based on the assigned product tiers, and provides the generated tiered GUI to a customer via a user device of user devices 210A-N as described with respect to block 103 of method 100 of FIG. 1. The customer feedback module 206 can be in communication with any appropriate number of user devices 210A-N via any appropriate network. User devices 210A-N can include any appropriate types of computer devices (e.g., such as computing device 400 of FIG. 4) that are capable of displaying a GUI to a user and receiving feedback from the user via the GUI, including but not limited to mobile devices and personal computers. The customer feedback module 206 receives customer feedback from a user device of user devices 210A-N via the tiered GUI, and provides the received customer feedback to product valuation module 207, as described with respect to block 104 of method 100 of FIG. 1.

Product valuation module 207 updates the valuations of one or more of the set of offered products based on customer feedback received from the customer feedback module 206. In some embodiments of the invention, for a product that was not purchased by the customer, the product valuation can be reduced by product valuation module 207. In some embodiments of the invention, for a product that was purchased by the customer, the product valuation can be increased by product valuation module 207. The product valuations of any appropriate number of products of the set of offered products can be adjusted by product valuation module 207. In some embodiments of the invention, the valuation of a given product can be determined by product valuation module 207 based on a number of times the given product is purchased (or not purchased) from a particular tier over a number of instances of customer feedback from customer feedback module 206. The updated valuations are provided to feature discovery module 208, which determines and updates relationships between product features, customer attributes, and product valuations for the set of offered products based on the customer feedback. Product valuation module 207 and feature discovery module 208 can operate as described with respect to block 105 of method 100 of FIG. 1.

The updated valuations are provided to tier assignment module 205, which updates the product tiers based on the product revenue values and updated product valuations as described with respect to block 106 of method 100 of FIG. 1. The customer feedback module 206 updates the tiered GUI based on the updated product tiers from tier assignment module 205 as described with respect to block 103 of method 100 of FIG. 1, and provides the updated tiered GUI to another customer via a user device of user devices 210A-N. The product valuations; relationships between product features, product valuations, and customer attributes; and product tiers can be updated by product valuation module 207, feature discovery module 208, and tier assignment module 205 of system 200 for any instance of customer feedback received by customer feedback module 206 throughout operation of system 200, and the tiered GUI that is generated by customer feedback module 206 is updated based on the updated product tiers from tier assignment module 205. The loop including tier assignment module 205, customer feedback module 206, product valuation module 207, and feature discovery module 208 can cause the respective product valuation of each product of the set of offered products to be learned by system 200 using the tiered GUI, such that the product valuations will each converge over time.

The relationships between product valuations, customer attributes, and product features are provided from feature discovery module 208 to selection policy module 209. Embodiments of selection policy module 209 can accumulate product data that is generated by system 200 throughout a time period (e.g., a season), and, based on the time period elapsing and a new set of new product candidates 201 becoming available, can be used by selector 202 to determine a new set of selected new products 203 from the new set of new product candidates 201, as described with respect to blocks 107 and 108 of method 100 of FIG. 1. The new set of selected new products 203 can be included in a new set of offered products, including staple products 104, for initial assignment into product tiers by tier assignment module 205 according to blocks 101 and 102 of FIG. 1. In some embodiments of the invention, one or more products that are included in selected new products 203 during a first time period are moved into staple products 104 in a subsequent time period.

For example, in embodiments of system 200 of FIG. 2, there may initially be 1000 staple products 204 and 50 selected new products 203. Tier assignment module 205 can initially sort 20 of the staple products 204 into the first tier, and 10 of the new products into the second tier, such that these 30 products in combination are determined to generate an optimized total revenue based on a combined neural-network valuation of the respective product valuations and respective revenue values of each product of the set 30 sorted products. These 30 products may or may not individually rank highest among the original 1050 products in terms of individual sorting attributes (e.g., valuation and/or revenue), but as a combination when displayed in the tiered GUI, these 30 products are determined by tier assignment module 205 to generate the highest benefit to the seller and buyer. Within each tier, the tiered GUI can display products in a linear ordering based on any appropriate product attributes, e.g., price, popularity, and/or relevance, in various embodiments of the present invention.

It is to be understood that the block diagram of FIG. 2 is not intended to indicate that the system 200 is to include all of the components shown in FIG. 2. Rather, the system 200 can include any appropriate fewer or additional components not illustrated in FIG. 2 (e.g., additional memory components, embedded controllers, functional blocks, connections between functional blocks, modules, inputs, outputs, etc.). Further, the embodiments described herein with respect to system 200 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

FIG. 3 shows a machine learning based tiered GUI 300 in accordance with one or more embodiments of the present invention. Embodiments of a GUI such as GUI 300 can be generated in block 103 of method 100 of FIG. 1 by a customer feedback module such as customer feedback module 206 of system 200 of FIG. 2. A GUI such as GUI 300 can be displayed to a customer via any appropriate user device, e.g., any of user devices 210A-N of FIG. 2. The tiered GUI 300 is generated based on a set of offered products that includes products 301A-F and products 302A-J, which are sorted into a first product tier 303 and a second product tier 304. First product tier 303 includes products 301A-F, and second product tier 304 includes products 302A-J. As shown in GUI 300 of FIG. 3, products 301A-F in first product tier 303 are displayed with a higher prominence level (e.g., at a top of the GUI 300 with relatively larger graphics and/or video) than products 302A-J in second product tier 304 (e.g., lower in the GUI 300 with relatively smaller graphics). The set of offered products 301A-F and 302A-J can include any appropriate types of products in various embodiments of the invention, including but not limited to clothing and accessories. In some embodiments of the invention, the tiered GUI 300 can include multiple pages that can be navigated by a customer; subsequent pages in the tiered GUI 300 can include lower-tiered products (e.g., a third or fourth tier of products).

Tiered GUI 300 of FIG. 3 is shown for illustrative purposes only. For example, embodiments of a tiered GUI such as is illustrated by GUI 300 can include any appropriate number of tiers, and each tier can include any appropriate number of products. Further, each product displayed in a tiered GUI such as tiered GUI 300 can be displayed in any appropriate manner. Further, a tiered GUI such as tiered GUI 300 can include any appropriate additional features.

Turning now to FIG. 4, a computer system 400 is generally shown in accordance with an embodiment. The computer system 400 can be an electronic, computer framework comprising and/or employing any number and combination of computing devices and networks utilizing various communication technologies, as described herein. The computer system 400 can be easily scalable, extensible, and modular, with the ability to change to different services or reconfigure some features independently of others. The computer system 400 may be, for example, a server, desktop computer, laptop computer, tablet computer, or smartphone. In some examples, computer system 400 may be a cloud computing node. Computer system 400 may be described in the general context of computer system executable instructions, such as program modules, being executed by a computer system. Generally, program modules may include routines, programs, objects, components, logic, data structures, and so on that perform particular tasks or implement particular abstract data types. Computer system 400 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, the computer system 400 has one or more central processing units (CPU(s)) 401a, 401b, 401c, etc. (collectively or generically referred to as processor(s) 401). The processors 401 can be a single-core processor, multi-core processor, computing cluster, or any number of other configurations. The processors 401, also referred to as processing circuits, are coupled via a system bus 402 to a system memory 403 and various other components. The system memory 403 can include a read only memory (ROM) 404 and a random access memory (RAM) 405. The ROM 404 is coupled to the system bus 402 and may include a basic input/output system (BIOS), which controls certain basic functions of the computer system 400. The RAM is read-write memory coupled to the system bus 402 for use by the processors 401. The system memory 403 provides temporary memory space for operations of said instructions during operation. The system memory 403 can include random access memory (RAM), read only memory, flash memory, or any other suitable memory systems.

The computer system 400 comprises an input/output (I/O) adapter 406 and a communications adapter 407 coupled to the system bus 402. The I/O adapter 406 may be a small computer system interface (SCSI) adapter that communicates with a hard disk 408 and/or any other similar component. The I/O adapter 406 and the hard disk 408 are collectively referred to herein as a mass storage 410.

Software 411 for execution on the computer system 400 may be stored in the mass storage 410. The mass storage 410 is an example of a tangible storage medium readable by the processors 401, where the software 411 is stored as instructions for execution by the processors 401 to cause the computer system 400 to operate, such as is described herein below with respect to the various Figures. Examples of computer program product and the execution of such instruction is discussed herein in more detail. The communications adapter 407 interconnects the system bus 402 with a network 412, which may be an outside network, enabling the computer system 400 to communicate with other such systems. In one embodiment, a portion of the system memory 403 and the mass storage 410 collectively store an operating system, which may be any appropriate operating system, such as the z/OS or AIX operating system from IBM Corporation, to coordinate the functions of the various components shown in FIG. 4.

Additional input/output devices are shown as connected to the system bus 402 via a display adapter 415 and an interface adapter 416 and. In one embodiment, the adapters 406, 407, 415, and 416 may be connected to one or more I/O buses that are connected to the system bus 402 via an intermediate bus bridge (not shown). A display 419 (e.g., a screen or a display monitor) is connected to the system bus 402 by a display adapter 415, which may include a graphics controller to improve the performance of graphics intensive applications and a video controller. A keyboard 421, a mouse 422, a speaker 423, etc. can be interconnected to the system bus 402 via the interface adapter 416, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 4, the computer system 400 includes processing capability in the form of the processors 401, and, storage capability including the system memory 403 and the mass storage 410, input means such as the keyboard 421 and the mouse 422, and output capability including the speaker 423 and the display 419.

In some embodiments, the communications adapter 407 can transmit data using any suitable interface or protocol, such as the internet small computer system interface, among others. The network 412 may be a cellular network, a radio network, a wide area network (WAN), a local area network (LAN), or the Internet, among others. An external computing device may connect to the computer system 400 through the network 412. In some examples, an external computing device may be an external webserver or a cloud computing node.

It is to be understood that the block diagram of FIG. 4 is not intended to indicate that the computer system 400 is to include all of the components shown in FIG. 4. Rather, the computer system 400 can include any appropriate fewer or additional components not illustrated in FIG. 4 (e.g., additional memory components, embedded controllers, modules, additional network interfaces, etc.). Further, the embodiments described herein with respect to computer system 400 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a processor, a set of offered products;
sorting the set of offered products into a plurality of tiers;
generating an initial tiered graphical user interface (GUI) based on the sorting;
receiving customer feedback via the tiered GUI;
updating the sorting of the set of offered products into the plurality of tiers based on the received customer feedback; and
generating an updated tiered GUI based on the updated sorting.

2. The computer-implemented method of claim 1, wherein the initial tiered GUI comprises a first tier comprising a first plurality of products consisting of staple products, and a second tier comprising a second plurality of products comprising staple products and new products, and wherein the first plurality of products is displayed with a higher prominence than the second plurality of products in the tiered GUI.

3. The computer-implemented method of claim 1, wherein sorting the set of offered products into the plurality of tiers is performed based on a respective product valuation and respective revenue value of each product of the set of offered products.

4. The computer-implemented method of claim 3 further comprising updating a product valuation of at least one product of the set of offered products based on the customer feedback, wherein updating the sorting of the set of offered products into the plurality of tiers is performed based on the updated product valuation.

5. The computer-implemented method of claim 4 further comprising determining a relationship between a feature of the at least one product, a customer attribute associated with the customer feedback, and the product valuation of the at least one product.

6. The computer-implemented method of claim 5 further comprising determining a new product selection policy based on the relationship between the feature of the at least one product and the product valuation of the at least one product, and selecting at least one new product to add to a new set of offered products based on the new product selection policy.

7. The computer-implemented method of claim 1, wherein the received set of offered products is selected based on a combined neural-network valuation of the respective product valuation and respective revenue value of each product of the set of offered products in the plurality of tiers.

8. A system comprising:
a memory having computer readable instructions; and
one or more processors for executing the computer readable instructions, the computer readable instructions controlling the one or more processors to perform operations comprising:
receiving a set of offered products;
sorting the set of offered products into a plurality of tiers;
generating an initial tiered graphical user interface (GUI) based on the sorting;
receiving customer feedback via the tiered GUI;
updating the sorting of the set of offered products into the plurality of tiers based on the received customer feedback; and
generating an updated tiered GUI based on the updated sorting.

9. The system of claim 8, wherein the initial tiered GUI comprises a first tier comprising a first plurality of products consisting of staple products, and a second tier comprising a second plurality of products comprising staple products and new products, and wherein the first plurality of products is displayed with a higher prominence than the second plurality of products in the tiered GUI.

10. The system of claim 8, wherein sorting the set of offered products into the plurality of tiers is performed based on a respective product valuation and respective revenue value of each product of the set of offered products.

11. The system of claim 10 further comprising updating a product valuation of at least one product of the set of offered products based on the customer feedback, wherein updating the sorting of the set of offered products into the plurality of tiers is performed based on the updated product valuation.

12. The system of claim 11 further comprising determining a relationship between a feature of the at least one product, a customer attribute associated with the customer feedback, and the product valuation of the at least one product.

13. The system of claim 12 further comprising determining a new product selection policy based on the relationship between the feature of the at least one product and the product valuation of the at least one product, and selecting at least one new product to add to a new set of offered products based on the new product selection policy.

14. The system of claim 8, wherein the received set of offered products is selected based on a combined neural-network valuation of the respective product valuation and respective revenue value of each product of the set of offered products in the plurality of tiers.

15. A computer program product comprising a computer readable storage medium having program instructions embodied therewith, the program instructions executable by one or more processors to cause the one or more processors to perform operations comprising:
receiving a set of offered products;
sorting the set of offered products into a plurality of tiers;
generating an initial tiered graphical user interface (GUI) based on the sorting;
receiving customer feedback via the tiered GUI;
updating the sorting of the set of offered products into the plurality of tiers based on the received customer feedback; and
generating an updated tiered GUI based on the updated sorting.

16. The computer program product of claim 15, wherein the initial tiered GUI comprises a first tier comprising a first plurality of products consisting of staple products, and a second tier comprising a second plurality of products comprising staple products and new products, and wherein the first plurality of products is displayed with a higher prominence than the second plurality of products in the tiered GUI.

17. The computer program product of claim 15, wherein sorting the set of offered products into the plurality of tiers is performed based on a respective product valuation and respective revenue value of each product of the set of offered products.

18. The computer program product of claim 17, wherein the operations further comprise updating a product valuation of at least one product of the set of offered products based on the customer feedback, wherein updating the sorting of the set of offered products into the plurality of tiers is performed based on the updated product valuation.

19. The computer program product of claim 18, wherein the operations further comprise determining a relationship between a feature of the at least one product, a customer attribute associated with the customer feedback, and the product valuation of the at least one product.

20. The computer program product of claim 19, wherein the operations further comprise determining a new product selection policy based on the relationship between the feature of the at least one product and the product valuation of the at least one product, and selecting at least one new product to add to a new set of offered products based on the new product selection policy.
